(19) United States
(12) Patent Application Publication
(10) Pub. No.: US 2004/0172308 A1
(43) Pub. Date: Sep. 2, 2004

(54) Method of generating insurance business by providing an on-site underwriter

(76) Inventor: Joseph D. Macchia, Fort Worth, TX (US)

Correspondence Address: AKIN, GUMP, STRAUSS, HAUER & FELD, L.L.P., 300 WEST 6TH STREET, SUITE 2100, AUSTIN, TX, 78701, US

(21) Appl. No.: 09/923,933

(22) Filed: Aug. 7, 2001

(51) Int. Cl. G06F 17/60

(52) U.S. Cl. 705/4

(57) ABSTRACT

An agent assistance program (AAP) is disclosed for evaluating business potential of a general insurance agency, insurance agent or broker and, if justified by the business potential, locating an insurance underwriter in the office of the general insurance agency. The evaluation is based upon a potential increase in business. An underwriter assigned to a particular agency, agent or broker is provided with a computer configured to access an affiliated insurance company's network and/or database to facilitate the underwriter's use of the insurance company's rating system. The workstation may be periodically updated with rating information relevant to the insurance agent so that the underwriter is able to provide a quote in the event of a database, network or communication link outage.

### BACKGROUND OF THE INVENTION

1. Technical Field

The invention relates generally to a method of generating insurance business and, more specifically, to generating insurance business for an insurance company by providing an in-house insurance underwriter at the office of an insurance producer.

2. Description of the Related Art

The insurance business is organized into several different levels, or “tiers.” One tier consists of insurance companies that provide basic packages, with specific rates determined by various qualifying factors such as, in the case of life insurance, age, weight and general overall health. Within the insurance company tier, there are independent insurance companies, which develop their own insurance rates and insurance policies, and there are insurance companies that depend upon a rating bureau, another type of insurance organization that sets specific rates and policies or provides data from many insurance companies which can be used to set rates.

Each rating bureau, such as the Insurance Service Office (“ISO”) or the American Association of Insurance Services (“AAIS”), publishes a Manual of Rules and Rates which is a list of premium rates or loss costs, classifications of policyholders and rules for coverage. The classification of policyholders is called a “class plan,” or a division of the policyholders into groups according to the risk involved with insuring the particular group. Typically, a numerical code is assigned to a particular group based upon factors such as, in the case of auto insurance, age, sex and history or, in the case of medical insurance, a policyholder's medical history.

Another tier of the insurance business consists of producers, i.e. agents, solicitors, brokers of other persons who sell insurance. Many producers are organized according to the American agency system in which a producer is compensated based upon a commission on the insurance policies the producer actually sells. Some insurance companies, rather than being organized in the American agency system, are direct writers, i.e., insurance companies that sell their policies through salaried employees or agents, each of whom exclusively represent the particular insurance company.

Although many producers use a Manual of Rates and Rules in order to sell policies, frequently there are situations in which a potential policyholder does not fit neatly into a particular classification, or class. In this case, an insurance company underwriter may approve a deviation rate, which is an adjustment of a published rate, either upward or downward, based upon the specific circumstances of the potential policyholder. Of course, an underwriter may also determine that the potential policyholder is not eligible for insurance. The underwriting process can be time-consuming and inefficient for both the insurance company and the producer, particularly if the producer has a high volume of business. In such a case, the only possible solution for a producer, agency or insurance company may be to increase their staff to handle the increased communication overhead. Regardless of a staff increase or other strategy the general agent or agency may employ to address this issue, the underwriting process may be so time-consuming that potential policyholders become motivated to look elsewhere for a solution to their insurance needs with the result that the insurance company loses the business the potential customer might have provided.

### SUMMARY OF THE INVENTION

An Agent Assistance Program (AAP) is disclosed for evaluating business potential in a general insurance agency and, if justified by the business potential, locating an insurance underwriter at the office of the general insurance agency. A general agent or insurance agency is evaluated based upon the amount of business that may be generated by the AAP. This evaluation is based upon the potential increase in business generated by providing customers a faster response to a request for an insurance quote. If the potential increase in business is greater than a specific threshold, then an underwriter is assigned by the insurance company to the agent's office. Typically, a locally assigned underwriter employing the disclosed method can ensure that an agent's customer receives an insurance quote within twenty-four hours.

An underwriter assigned to a particular agent is provided with a work station or computer configured to access an affiliated insurance company's network and/or database to facilitate the underwriter's use of the insurance company's rating system. The workstation may be periodically updated with rating information relevant to the insurance agent so that the underwriter is able to provide a quote in the event of a database, network or communication link outage. An update may take such forms as a nightly data download through standard communication mediums such as a telephone line and modem or the Internet. Another method of updating the underwriter's workstation is to periodically deliver to the underwriter a storage medium such as a compact disk (CD) that is then loaded onto the underwriter's work station or computer.

In an alternative embodiment of the AAP, a specific underwriter can be assigned to one or more insurance agents who either individually or collectively generate enough potential business to justify a dedicated underwriter. The one or more agents then communicate with the underwriter through a public or private communication medium such as a fax machine, a web-based user interface, an intranet, a metro area network (MAN) or a wide area network (WAN). In addition, additional raters can be stationed at the insurance company and dedicated to services requests from AAP underwriters.

The advantages of the disclosed AAP include providing an insurance agent the ability to provide quotes to more potential customers and generate additional business than otherwise possible because the underwriter can provide the agent with faster insurance quotes within exception classes. In other words, the AAP underwriter can provide an insurance agent the ability to approve a particular business opportunity more quickly than currently possible. In this manner, the agent can generate business rather than waiting for approval and possibly losing the business. The underwriter can also provide more general assistance within the insurance agents office such as answering the phone when all the insurance agent's employees are otherwise occupied. The underwriter is also an advocate for the insurance company within the insurance agents office. In this manner, revenues for both the insurance company and insurance brokers and agents is increased.

As will became clear from the description of the invention below, the method of the claimed subject matter is applicable to businesses other than that of insurance companies, agents and/or agencies such as the reinsurance business, retail sales and health maintenance organizations (“HMOs”).

### BRIEF DESCRIPTION OF THE FIGURES

The invention can be better understood with reference to the following figures. The components in the figures are not necessarily to scale, emphasis instead being placed upon illustrating the principles of the invention. Moreover, in the figures, like reference numerals designate corresponding parts throughout the different views.

FIG. 1 is a diagram of the insurance business as it typically functions today, with multiple levels, or tiers.

FIG. 2 is a diagram of the insurance business of FIG. 1 with an Agent Assistance Program (AAP) in place.

FIG. 3 is a flowchart of an insurance transaction conducted in accordance with the method of the claimed subject matter.

FIG. 4 is a table illustrating a potential profit from an AAP with a forty percent hit ratio.

FIG. 5 is a table illustrating a potential profit from an AAP with a twenty-five percent hit ratio.

### DETAILED DESCRIPTION OF THE FIGURES

Although described with particular reference to the insurance business, the following method is applicable to a number of other industries such as the reinsurance market, retail sales and health maintenance organizations (“HMOs”). The method of the claimed subject matter may be used advantageously in these other business settings as well as in the retail insurance business.

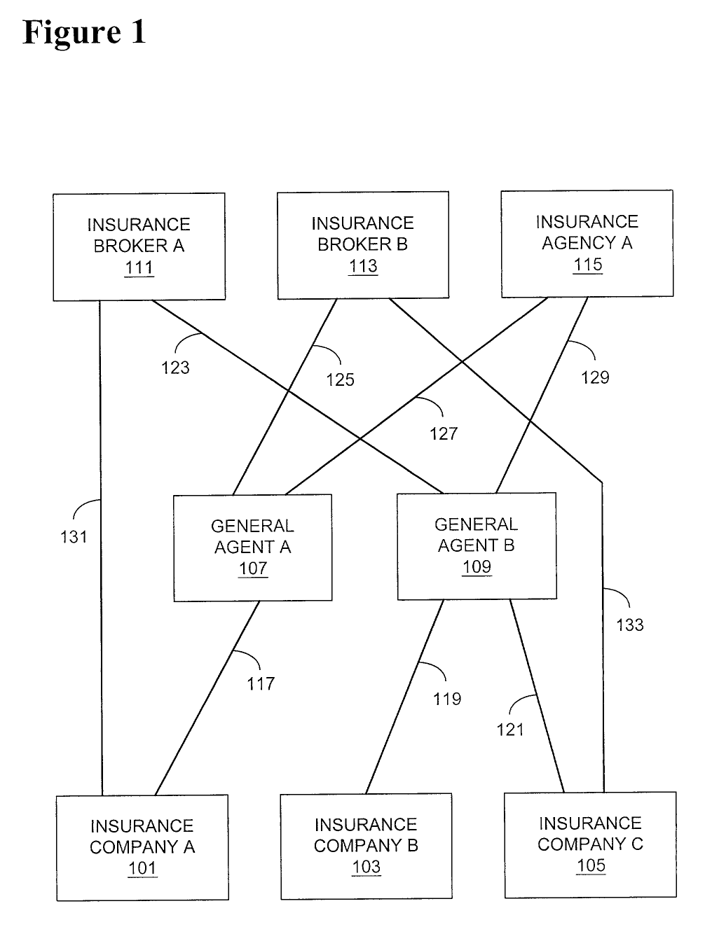

Turning now to the figures, FIG. 1 illustrates the structure of the insurance business as it exists today. A first level, or tier, of the insurance business consists of an insurance company A 101, an insurance company B 103 and an insurance company C 105. A second level consists of general agents, or wholesalers, such as a general agent A 107 and a general agent B 109. A third level consists of insurance producers, i.e., agents or agencies, such as an insurance broker A 111, an insurance broker B 113 and an insurance agency A 115. An insurance agency such as insurance agency A 115 is typically a group of affiliated agents but can also consist of a single agent.

In this example, the insurance broker A 111 sells policies underwritten by insurance company A 101, insurance company B 103 and insurance company C 105. If insurance broker A 111 sells a policy offered by insurance company B 103 or insurance company C 105, the insurance broker 111 deals through the general agent B 109, as indicated by a line 123. The general agent 109 deals directly with insurance company B 103 and insurance company C 105, as indicated by a line 119 and a line 121, respectively. The insurance broker 111 can sell policies of insurance company A 101 without going through a general agent such as the general agents A and B 107 and 109, as indicated by a line 13 1. The insurance broker B 113 sells policies underwritten by insurance company A 101, through the general agent 107, as indicated by a line 125 (between insurance broker B 113 and general agent A 107) and a line 117 (between general agent A 107 and insurance company A 101). Insurance broker B 113 also sell policies underwritten by insurance company C 105 without going through general agent 107 or 109, as indicated by a line 133. The insurance agency A 115 sells policies underwritten by the insurance companies A 101, B 103 and C 105 but only through the general agents 107 and 109, as indicated by a line 127 and a line 129 respectively.

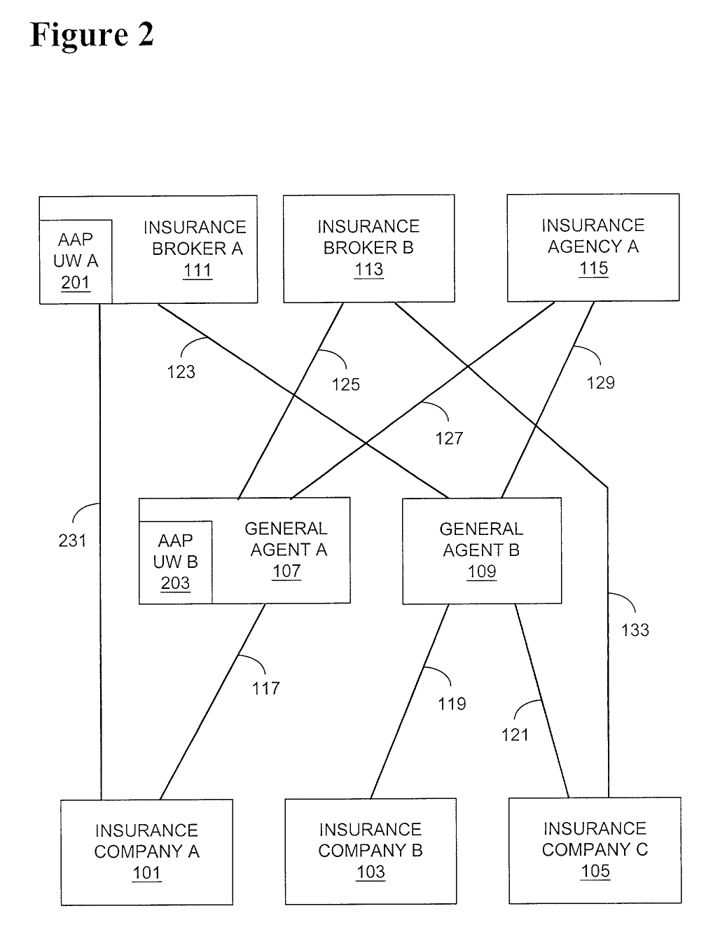

FIG. 2 illustrates an implementation of the Agent Assistance Program (AAP) in the context of the insurance business as illustrated in FIG. 1. FIG. 2 also includes the insurance companies A, B and C 101, 103 and 105, the general agents A and B 107 and 109, the insurance brokers A and B 111 and 113 and the insurance agency A 115. FIG. 2 also includes an AAP underwriter A 201, who is situated at the office of the insurance broker A 111, and an AAP underwriter B 203, who is situated at the office of the general agent A 107. Typically, insurance underwriters are located at the insurance company A, B or C 101, 103 and 105 and provide rates for a number of insurance agents, agencies and/or brokers such as insurance broker A 111, insurance broker B 113, insurance agency A 1 5, general agent A 107 and general agent B 109. The AAP underwriters A and B 201 and 203 are equipped with computers or workstations (not shown) configured to perform their underwriting duties. These computers or workstations have access to the insurance company A 101 computer, network or database through a communication medium such as a modem or the Internet and receive periodic updates of relevant data such as insurance table and rates. In an alternative embodiment, the computer or workstations are stand-alone machines and receive periodic updates by copying data from a computer storage medium such as a compact disk or disks sent by the insurance company A 101.

The AAP underwriter A 201 is assigned by the insurance company A 101 to assist in the business of the insurance broker A 111 and the AAP underwriter B 203 is assigned to assist in the business of the general agent A 107. The duties of the AAP underwriter A 201 and the AAP underwriter B 203 are similar and include providing either the corresponding insurance broker A 111 or the general agent A 107 with insurance rates for potential customers that, for one reason or another, do not conform to a standard insurance class within the type of insurance that the customer is requesting to purchase.

Duties of the AAP underwriters A and B 201 and 203 may include answering phone calls from potential customers when other employees of either the insurance broker A 113 or the general agent A 107 respectively are too busy to do so themselves. The placement of the AAP underwriters A and B 201 and 203 at the locations of the insurance producers insurance broker A 111 and general agent A 107 enables these producers to provide potential customers with an insurance quote faster than is otherwise possible and typically within twenty-four hours. In addition, the AAP underwriter A 201 is an advocate for the insurance company A 101 that may make it more likely that insurance agent A 111 writes his new policies through the insurance company A 101 rather than through a competing insurance provider such as insurance companies B or C 103 and 105.

In this example, in order to write a policy from either insurance company B or C 103 and 105, the insurance broker A 111 would first contact the general agent B 109, who would then contact either the insurance company B or C 103 and 105. This extra step increases the time required to provide the insurance broker A 111 with the information needed to provide the potential customer with an insurance quote. Even if the insurance broker A 111 could contact the insurance company B or C 103 and 105 directly, without the intermediate step of contacting the general agent B 109, this process would typically take longer to provide an insurance quote than it does through the AAP underwriter A 201. The insurance broker A 111 is also more likely to do business with an underwriter that he or she is in contact with on a regular basis than with a pool of underwriters available at the insurance company B or C 103 and 105.

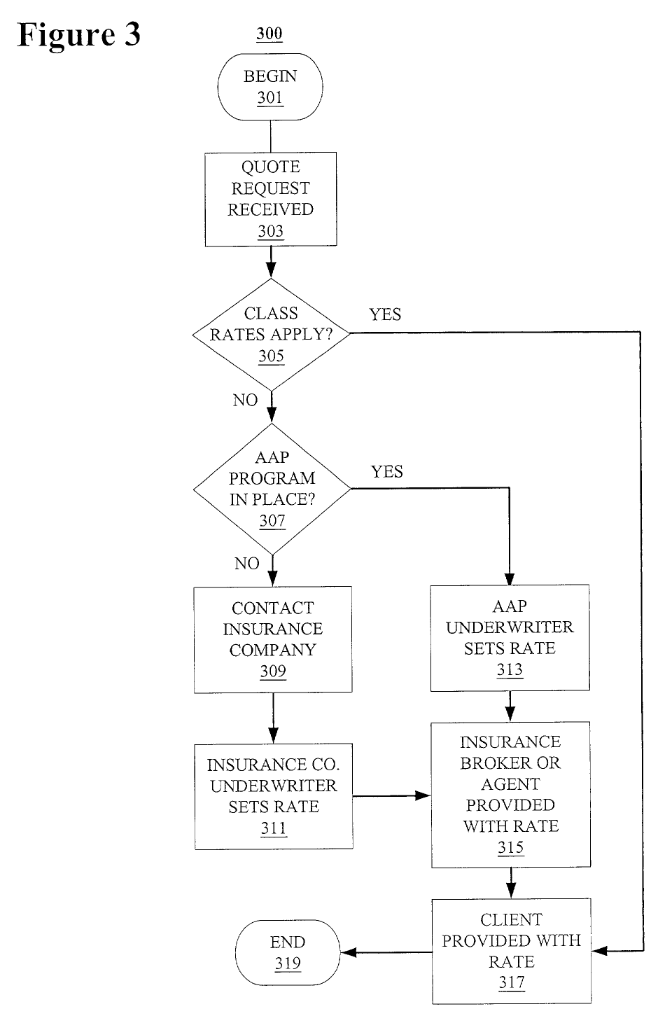

FIG. 3 is a flowchart of an insurance rate determination process 300 conducted according to the method of the claimed subject matter. The process 300 starts in a Begin step 301 and control proceeds immediately to a Quote Request Received step 303. In this example, a potential client has contacted the insurance broker A 111 (FIGS. 1 and 2) requesting insurance coverage, the particular type of which is not important for the purposes of the example because the method of the claimed subject matter works equally well regardless of the type of insurance offered by the insurance broker A 111. Control then proceeds to a Class Rates Apply step 305 in which the insurance broker A 111 determines whether or not the potential customer and the requested insurance coverage fits neatly into a class as defined by the Manual of Rules and Rates. If so, control proceeds to a Client Provided With Rate step 317 in which the insurance broker A 111 calculates a price of the requested policy according to the particular class plan and the Manual of Rates and Rules and then provides the potential client with the price. The potential client can then decide whether or not to purchase the policy at the provided price. The ratio of the number of clients who decide to purchase the policy to the number of clients who are provided with a price is the “hit ratio.” For example, if during a work week, one hundred (100) potential clients request a quote and forty (40) of them end up purchasing a policy, then the hit ratio is 40/100 or forty percent (40%). Once the client has been provided with a price, or rate, control proceeds to a End step 319 in which this particular rate determination process is complete.

If in step 305, the insurance broker A 111 determines that a class rate does not apply to the particular quote request, possibly because of some unusual characteristic of either the request or the potential client, then control proceed to a Agent Assistance Program (AAP) Program in Place step 307 in which the path of the process 300 is determined by whether or not the insurance broker A 111 has an AAP underwriter A 201 in residence at the office of the insurance broker A 111. In another embodiment of the invention, the AAP underwriter A 201 can be located at another office rather than at the office of the insurance broker A 111. The insurance broker A 111 would then contact the AAP underwriter 201 through standard communication mediums. If the insurance broker A 111 has a relationship with an AAP underwriter such as the AAP underwriter 201, either in the office of insurance broker A 111 or reachable through the telephone or another electronic medium such as email or the Internet, control then proceeds to a AAP underwriter Sets Rate 313 step in which the AAP underwriter calculates the rate of the policy requested by the potential customer or determines that the insurance company A 101 would be unwilling to accept the potential business. The calculated rate (or rejection) is then provided to the insurance broker A 111 in a Insurance Broker or Agent Provided With Rate step 315. Control then proceeds to a Client Provided With Rate step 317 where the insurance broker A 111 provides the client with the calculated rate and finally proceeds to the End step 317 as described above.

If in step 307 an AAP underwriter is not in place, then control proceeds to a Contact Insurance Company step 309. This represents the path a typical insurance broker such as the insurance broker B 113 or an insurance agency such as insurance agency B 115 (FIGS. 1 and 2) must take. In step 309, the insurance broker B 113 or the insurance agency 115 contacts one of the insurance companies A, B or C 101, 103 or 105 (FIGS. 1 and 2) and an underwriter (not shown) at the contacted insurance company determines the rate on the policy requested by the potential customer in a Insurance Company Underwriter Sets Rate step 311. In the business scenario represented by steps 309 and 311, the insurance broker B 113 and the insurance agency A 115 are at a business disadvantage to the insurance broker A 111 because time is required, and thus lost, by the addition of the step 309. Time is also lost by the typical response time of an insurance company underwriter who is required to respond to multiple requests from multiple general agents, insurance brokers and insurance agencies such as general agent B 109, insurance broker B 113 and insurance agency A 115. In addition, insurance company A, B or C 101, 103 and 105 may give preference to a quote request from a direct agent rather than a request from an insurance broker A 111. Once the insurance company A, B or C 101, 103 and 105 responds with a quote, control proceeds to the step 315 in which the insurance broker A 111 is provided with the rate. Control then proceeds to the Provide Client With Rate step 317 and then to the End step 319 as explained above.

Using the AAP underwriter B 203 (FIG. 2) as another example of the method of the claimed subject matter, a process similar to process 300 (FIG. 3) is employed. In this example, the AAP underwriter B 203 is situated at the office of the general agent A 107 and the potential customer is a general agent such as the insurance broker B 113 or a insurance agency such as the insurance agency A 115 (FIGS. 1 and 2) rather than the final consumer as in the previous example. The advantages of employing the method of the claimed subject matter in this example are the similar to the advantages described above in conjunction with process 300, primarily a reduction in the time it takes the general agent A 107 to provide a quote to the insurance broker B 113 or insurance agency A 115 and a corresponding business advantage over the general agent B 109 (FIGS. 1 and 2) who does not have the benefit of the AAP underwriter 203. Of course this time savings is also reflected in the time it takes the insurance broker B 113 or the insurance agency A 115 to respond to their final customer who generated the quote request in the first place.

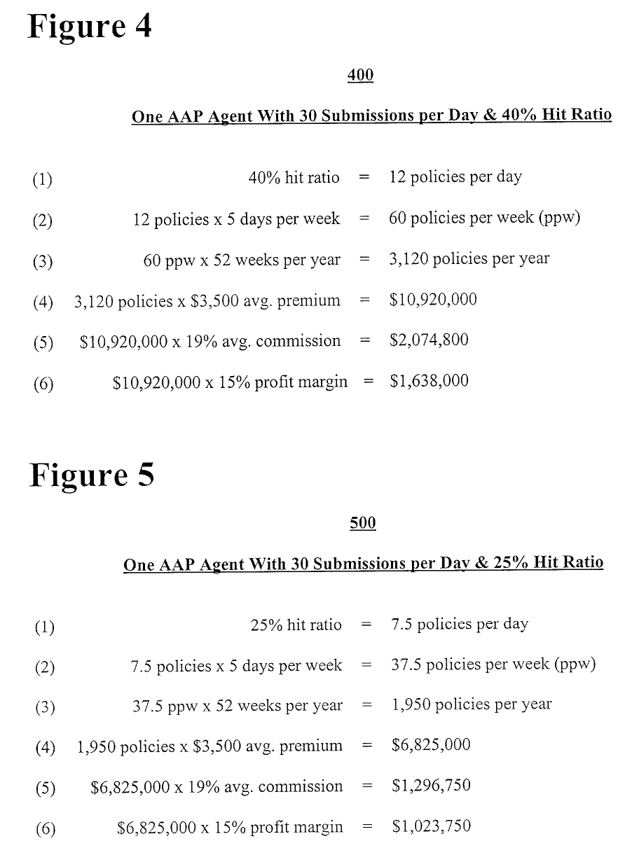

Advantages other than a time savings are also possible. For example, the AAP underwriter A 201 can provide an extra person to perform general office duties such as answering the phone when other employees of the insurance broker A 111 are otherwise occupied. There are also advantages to the method of the claimed subject matter for the insurance company A 101 (FIGS. 1 and 2) such as the fact that the AAP underwriters A and B 201 and 203 are advocates for the insurance company A 101 at the offices of the insurance broker A 111 and the general agent A 107, respectively. The financial advantages for the insurance company A 101 in terms of increased revenue are illustrated below in conjunction with FIGS. 4 and 5. Other advantages will also become apparent to those with skill in the art as they practice the claimed subject matter.

FIG. 4 is a table 400 that illustrates an example of revenues the AAP can generate. Table 400 is based upon an AAP underwriter, e.g. AAP underwriter B 203 (FIG. 2), that calculates rates for thirty (30) potential customers per day and has a forty percent (40%) “hit ratio,” or the percent of potential customers that actually buy insurance. As shown in line 1, if the AAP underwriter 201 calculates rates for thirty (30) potential customers and has a forty percent (40%) hit ratio, then the AAP underwriter 201 generates twelve (12) new policies per day for the insurance company A 101. As shown in line 2, twelve (12) policies per day are equal to sixty (60) policies per week (ppw). Line 3 illustrates that a rate of sixty (60) ppw maintained for fifty-two (52) weeks is equal to 3,120 new policies per year for insurance company A 101. If the average premium for a new policy is $3,500, then, as illustrated by line 4, the amount of income generated by the 3,120 policies is equal $10,920,000. As shown in line 5, if the general agent A 107 retains a nineteen percent (19%) commission, then the general agent A 107 has a revenue of $2,074,800 from the $10,920,000 of increased business. In addition as illustrated in line 6, the insurance company 101, assuming a profit margin of fifteen percent (15%), generates an additional $1,638,000 in revenue.

FIG. 5 is a table 500 that illustrates another example of the profit an AAP underwriter can generate. Table 500 is based upon an AAP underwriter, e.g. AAP underwriter 203 (FIG. 2), that calculates rates for thirty (30) potential customers per day and has a twenty-five percent (25%) hit ratio rather than the forty percent (40%) hit ratio of illustrated above in conjunction with FIG. 4. As shown in line 1, if the AAP underwriter 201 calculates rates for thirty (30) potential customers and has a twenty-five percent (25%) hit ratio, then the AAP underwriter 201 Generates 7.5 new policies per day for the insurance company A 101. As shown in line 2, 7.5 policies per day are equal to 37.5 ppw. Line 3 illustrates that a rate of 37.5 ppw maintained for fifty-two (52) weeks is equal to 1,950 new policies per year for insurance company A 101. If the average premium for a new policy is $3,500, then, as illustrated by line 4, the amount of revenue generated by the 1,950 policies is equal $6,825,000. As shown in line 5, if the general agent A 107 retains a nineteen percent (19%) commission, then the general agent A 107 has a revenue of $1,296,750 from the $6,825,000 in additional business. In addition as illustrated in line 6, the insurance company A, assuming a fifteen percent (15%) profit margin, generates an additional $1,023,750 of revenue. Although $1.2 million is less than $2 million and $1 million is less than the $1.6 million illustrated above in conjunction with FIG. 4, the AAP, even assuming a twenty-five percent (25%) hit ratio, generates enough additional revenue for both the insurance company and the insurance provider to justify the program.

While various embodiments of the application have been described, it will be apparent to those of ordinary skill in the art that many more embodiments and implementations are possible that are within the scope of this invention. Accordingly, the invention is not to be restricted except in light of the attached claims and their equivalents.

We claim:

1. A method of providing support to a seller of insurance, comprising the steps of:
identifying an insurance provider who is potentially suitable for a dedicated underwriter program sponsored by an insurance company;
evaluating the insurance provider based upon a threshold of potential business that the dedicated underwriter program can generate; and, if the fixed amount of potential business exceeds the threshold,
provide an insurance underwriter, employed by the insurance company for the exclusive use of the insurance provider, for generating one or more insurance quotes for the potential business; and
providing the one or more quotes to the insurance provider.

2. The method of claim 1, wherein the insurance provider is a general agent.

3. The method of claim 1, wherein the seller of provider is an insurance broker or a general agent.

4. The method of claim 1, wherein the insurance underwriter is located at an office of the insurance provider.

5. The method of claim 1, further comprising the step of providing the insurance underwriter with a computing device loaded with data related to an insurance rating system employed by the insurance company.

6. The method of claim 5, further comprising the step of periodically updating the data.

7. The method of claim 6 wherein the data are updated through a communication link between the computing device and the insurance company.

8. The method of claim 6 wherein the data are updated by a compact disc loaded on the computing device.

9. The method of claim 1, wherein the threshold of potential business is thirty insurance policies per day.

10. The method of claim 1, wherein the threshold of potential business is based upon a combination of a number of insurance policies written and a hit ratio.

11. A method of selling insurance, comprising the steps of
assigning an underwriter employed by an insurance company to an office of an insurance provider;
providing underwriting service from the underwriter to the insurance provider to determine a rate for a potential customer of the insurance provider; and
selling an insurance policy written by the insurance company to the potential customer based upon the rate.

12. The method of claim 11, wherein the insurance provider is a general agent.

13. The method of claim 11, wherein the insurance provider is an insurance broker or a general agent.

14. The method of claim 11, further comprising the step of providing underwriter with a computing device loaded with data related to an insurance rating system employed by the insurance company.

15. The method of claim 14, further comprising the step of periodically updating the data.

16. The method of claim 15 wherein the data are updated through a communication link between the computing device and the insurance company.

17. A method of distributed insurance underwriting, comprising the steps of:
locating a plurality of insurance underwriters at a plurality of locations, each location of the plurality of locations corresponding to a particular insurance provider of a plurality of insurance providers;
providing underwriting services to each the plurality of insurance providers from the corresponding insurance underwriters;
selling insurance through each insurance provider based upon the underwriting services of the corresponding insurance underwriter.

18. The method of claim 17, wherein the insurance provider is a general agent.

19. The method of claim 17, wherein the insurance provider is an insurance broker or a general agent.

20. The method of claim 17, further comprising the step of providing each underwriter with a computing device of a plurality of computing devices, each computing device loaded with data related to an insurance rating system employed by the insurance company.
